(19) United States
(12) Patent Application Publication
(10) Pub. No.: US 2020/0148219 A1
(43) Pub. Date: May 14, 2020

(54) VEHICULAR ACCESSORY CONTROL

(71) Applicant: INTERNATIONAL BUSINESS MACHINES CORPORATION, ARMONK, NY (US)

(72) Inventors: Lisa Seacat DeLuca, Baltimore, MD (US); Jeremy R. Fox, Georgetown, TX (US); Jeremy A. Greenberger, San Jose, CA (US); Kelley Anders, East New Market, MD (US)

(21) Appl. No.: 16/185,166

(22) Filed: Nov. 9, 2018

(51) Int. Cl. B60W 50/10; G06F 16/29; G06Q 30/06; G06N 20/00; B60Q 9/00; B60W 50/14; G06K 9/00

(52) U.S. Cl. CPC B60W 50/10; G06F 16/29; G06Q 30/0635; G06N 20/00; B60W 2540/00; B60W 50/14; G06K 9/00288; G06K 9/00791; G06K 9/00838; B60Q 9/00

(57) ABSTRACT

A method and system for enabling a vehicular accessory control improvement is provided. The method includes continuously monitoring user attributes associated with user actions occurring exterior to a vehicle. Vehicle control actions associated with controlling devices of the vehicle are determined in response to the user actions and activities occurring within the vehicle are monitored. The vehicle control actions are executed and self-learning software code associated with future instances of executing the vehicle control actions with respect to detecting future instances of user actions is generated.

### FIELD

The present invention relates generally to a method for automatically controlling vehicular accessories and in particular to a method and associated system for determining and executing vehicular control actions associated with external user actions.

### BACKGROUND

Determining conditions for vehicular accessory control typically includes an inaccurate process with little flexibility. Addressing specific vehicular control issues may involve an unreliable process that may be time consuming and require a large amount of resources. Accordingly, there exists a need in the art to overcome at least some of the deficiencies and limitations described herein above.

### SUMMARY

A first aspect of the invention provides vehicular accessory control improvement method comprising: continuously monitoring, by a processor of a hardware device within a vehicle via a plurality of sensors, user attributes associated with a plurality of user actions occurring exterior to the vehicle; determining, by the processor based on results of the continuously monitoring, vehicle control actions associated with controlling devices of the vehicle in response to the plurality of user actions; monitoring via a plurality of internal sensors of the vehicle, by the processor in response to the plurality of user actions, activities occurring within the vehicle; executing, by the processor based on results of the monitoring, the vehicle control actions; and generating, by the processor in response to the executing, self-learning software code associated with future instances of executing the vehicle control actions with respect to detecting future instances of the plurality of user actions.

A second aspect of the invention provides a computer program product, comprising a computer readable hardware storage device storing a computer readable program code, the computer readable program code comprising an algorithm that when executed by a computer processor of a hardware device, within a vehicle, implements a vehicular accessory control improvement method, the method comprising: continuously monitoring, by the processor via a plurality of sensors, user attributes associated with a plurality of user actions occurring exterior to the vehicle; determining, by the processor based on results of the continuously monitoring, vehicle control actions associated with controlling devices of the vehicle in response to the plurality of user actions; monitoring via a plurality of internal sensors of the vehicle, by the processor in response to the plurality of user actions, activities occurring within the vehicle; executing, by the processor based on results of the monitoring, the vehicle control actions; and generating, by the processor in response to the executing, self-learning software code associated with future instances of executing the vehicle control actions with respect to detecting future instances of the plurality of user actions.

A third aspect of the invention provides A hardware device, within a vehicle, comprising a computer processor coupled to a computer-readable memory unit, the memory unit comprising instructions that when executed by the computer processor implements a vehicular accessory control improvement method comprising: continuously monitoring, by the processor via a plurality of sensors, user attributes associated with a plurality of user actions occurring exterior to the vehicle; determining, by the processor based on results of the continuously monitoring, vehicle control actions associated with controlling devices of the vehicle in response to the plurality of user actions; monitoring via a plurality of internal sensors of the vehicle, by the processor in response to the plurality of user actions, activities occurring within the vehicle; executing, by the processor based on results of the monitoring, the vehicle control actions; and generating, by the processor in response to the executing, self-learning software code associated with future instances of executing the vehicle control actions with respect to detecting future instances of the plurality of user actions.

The present invention advantageously provides a simple method and associated system capable of determining conditions for vehicular accessory control.

### BRIEF DESCRIPTION OF THE DRAWINGS

FIG. 1 illustrates a system for improving automotive technology by determining and executing vehicular control actions associated with external user actions, in accordance with embodiments of the present invention.

FIG. 2 illustrates a flowchart detailing a process enabled by the system of FIG. 1 for improving automotive technology by determining and executing vehicular control actions associated with external user actions, in accordance with embodiments of the present invention.

FIG. 3 illustrates an internal structural view of the sensors/circuitry/logic of FIG. 1, in accordance with embodiments of the present invention.

FIG. 4 illustrates an implementation example associated with detecting externally located occupants of a vehicle, in accordance with embodiments of the present invention.

FIG. 5 illustrates an implementation example associated with detecting externally located items to be loaded within a vehicle, in accordance with embodiments of the present invention.

FIG. 6 illustrates a computer system for improving automotive technology by determining and executing vehicular control actions associated with external user actions, in accordance with embodiments of the present invention.

FIG. 7 illustrates a cloud computing environment, in accordance with embodiments of the present invention.

FIG. 8 illustrates a set of functional abstraction layers provided by cloud computing environment, in accordance with embodiments of the present invention.

### DETAILED DESCRIPTION

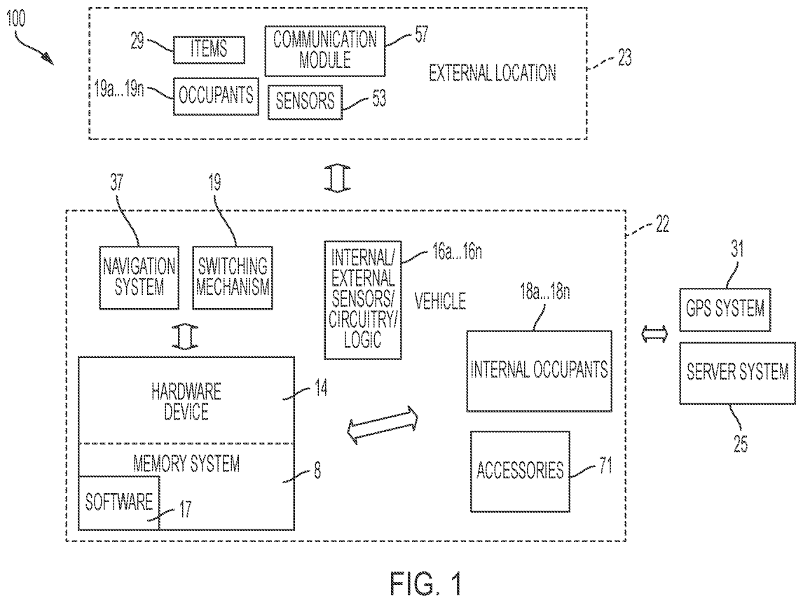

FIG. 1 illustrates a system 100 for improving automotive technology by determining and executing vehicular control actions associated with external user actions, in accordance with embodiments of the present invention. System 100 is enabled to execute a process for activating vehicular settings for a vehicle 22 equipped with user recognition. The process includes identifying internal/external sensors 16a . . . 16n integrated with vehicle 22 and determining a set of characteristics of a user associated with vehicle 22. Internal/external sensors 16a . . . 16n are configured retrieve data for detecting: that a user (e.g., any of occupants 19a . . . 19n) is approaching vehicle 22; additional individuals accompanying the user; and one or more objects meeting a set of criteria. The detection process results in activation of one or more devices and/or settings (e.g., turn on air conditioning, fold down seats, open an exterior door of vehicle 22, open an internal compartment of vehicle 22, etc.) for vehicle 22.

System 100 of FIG. 1 includes a communication module 57 (at an external location 23), a server system 25, and a global positioning satellite (GPS) (or any type of movement detection system) system 31 communicatively connected (e.g., via a network) to vehicle 22. The vehicle 22 includes a hardware device (e.g., onboard computer 14), a switching (control) mechanism 19, internal/external sensors 16a . . . 16n, a navigation system 37, and occupants 18a . . . 18n. External location 23 (e.g., a retail location) is associated with occupants 19a . . . 19n (of vehicle 22) retrieving items 29 (e.g., retail products). Sensors 53 (e.g., comprised by Internet of Things devices) are configured to detect items 29 and communicate (via a communication module) with sensors 16a . . . 16n and hardware device 14 for notifying vehicle that items 29 will be loaded into vehicle. In response, hardware device 14 may issue a command for activating switching mechanism for controlling accessories 71 (enable air conditioning, fold down seats, open an exterior door, open an internal compartment) of vehicle 22. Hardware device 14, navigation system 37, and switching mechanism 19 may include any type of hardware controller system(s) including, inter alia, an automobile integrated controller computer, a computer (PC), a laptop computer, a tablet, etc. Hardware device 14 includes a memory system 8. Memory system 8 stores program instructions 17 for enabling a process for determining and executing vehicular control actions associated with external user actions. Hardware device 14, navigation system 37, and switching mechanism 19 may each comprise a specialized hardware device comprising specialized (non-generic) hardware and circuitry (i.e., specialized discrete non-generic analog, digital, and logic-based circuitry) for executing a process described with respect to FIGS. 1-8. The specialized discrete non-generic analog, digital, and logic-based circuitry may include proprietary specially designed components (e.g., a specialized integrated circuit, such as for example an Application Specific Integrated Circuit (ASIC) designed for only implementing a process for improving automotive technology by determining and executing vehicular control actions associated with external user actions). Switching mechanism 19 comprises any type of electrical and/or mechanical control and switching mechanism (for automatically controlling functionality of all accessories 71 in vehicle 22) that may include proprietary specially designed electro/mechanical components (e.g., circuitry, switching relay, control motors, etc.). Accessories 71 may comprise any type of functional accessory in vehicle including, inter alia, a radio, air conditioning, power fold down seats, car doors, windows, etc. Internal/external sensors 16a . . . 16n may include any type of sensors for detecting internal and external occupants of vehicle 22. Internal/external sensors 16a . . . 16n may include, inter alia, optical sensors, temperature sensors, infrared sensors, speed sensors, GPS sensors, moisture sensors, pressure sensors, motion detector sensors, video cameras, etc. Sensors 53 may include any type of sensors for detecting items and individuals at a location. Sensors 53 may include, inter alia, optical sensors, temperature sensors, infrared sensors, speed sensors, GPS sensors, moisture sensors, pressure sensors, motion detector sensors, video cameras, etc.

The following process enabled by system 100 of FIG. 1 describes an implementation example for executing vehicular control actions (for a vehicle) associated with external user actions:

The aforementioned vehicle includes multiple sensors associated with adjustable electro/mechanical settings for modifying electro/mechanical devices of the vehicle. For example, electro/mechanical devices may include, inter alia, automated doors, automated movable windows, automated movable seats, automated rear hatch, automated movable side view mirrors, automated audio settings, automated radio station preferences, automated audio volume control, automated movable truck, automated movable cup holders, automated temperature control settings, automated movable cameras, etc.

The process is initiated when a set of observations/actions (associated with a user) are monitored by the system. For example, observations/actions may include, inter alia, real time purchases, image recognition, location-based attributes, etc. Real time purchases may include the following information: a type of purchase, a shape and size of purchase requiring more space in the vehicle, features of a purchase, a quantity purchases, etc. Image recognition may include detecting the following attributes/actions: a number of people approaching the vehicle, a type and demographic of people approaching the vehicle (e.g., children vs. adults), an identity of people approaching the vehicle, clothing of people approaching the vehicle (e.g., summer vs winter attire), objects being carried or pushed in shopping cart (e.g., a cup, groceries, large objects requiring trunk and/or seats placed down flat, cumulative items of all individuals, etc.), etc. Location based attributes may include: a known establishment address (e.g., a user is near a coffee shop and less than 10 minutes from returning to vehicle, it is possible the user will return to the car with a cup), nearby establishments (e.g., a user is near a shopping mall then the user is likely to return with packages), a known pattern of behavior based on location, long duration travel destinations, etc.

The set of observations/actions are mapped to the aforementioned adjustable electro/mechanical settings and the vehicle is configured to execute associated actioned based on results of the mapping process. Alternatively, an alert may be issued for notifying a driver to initiate an action.

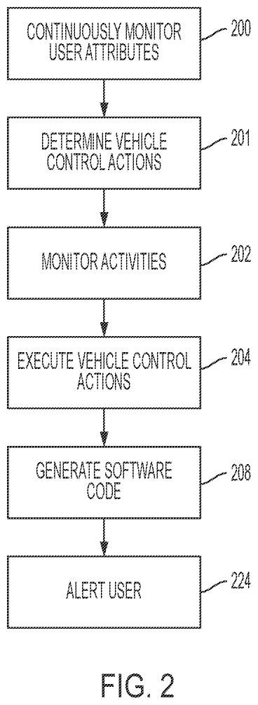

FIG. 2 illustrates a flowchart detailing a process enabled by system 100 of FIG. 1 for improving automotive technology by determining and executing vehicular control actions associated with external user actions, in accordance with embodiments of the present invention. Each of the steps in the algorithm of FIG. 2 may be enabled and executed in any order by a computer processor executing computer code. In step 200, user attributes are continuously monitored via a plurality of sensors integrated with a vehicle. Additionally, or alternatively, the plurality of sensors may be comprised by an Internet of Things (JOT) device of the user. The user attributes are associated with user actions occurring exterior to the vehicle (e.g., exiting a retail establishment with multiple packages). The user actions may include, inter alia, actions associated with items being purchased by the user, actions associated with a plurality of individuals currently located with the user and allocated for entering the vehicle, actions associated with a current geographical location of the user, etc. Additionally, a facial image recognition process with respect to the plurality of individuals may be executed.

In step 201, vehicle control actions are determined based on results of step 200. The vehicle control actions are associated with controlling devices of the vehicle in response to user actions. The vehicle control actions may include, inter alia, vehicle entry point actions, vehicle audio system actions, vehicle climate control actions, vehicle convenience apparatus actions, etc. In step 202, activities occurring within the vehicle are monitored via internal sensors of the vehicle. In step 204, the vehicle control actions are executed based on results of the monitoring of step 202. In step 208, self-learning software code is generated. The self-learning software code is associated with future instances of executing the vehicle control actions with respect to detecting future instances of the user actions. In step 224, an alert is generated and presented to the user. The alert indicates that the user actions are being executed.

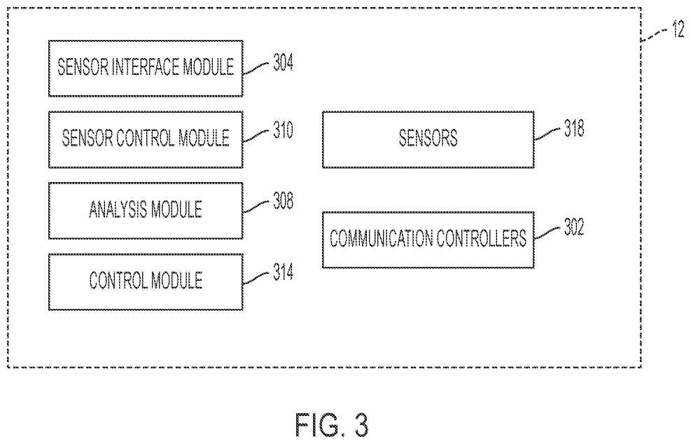

FIG. 3 illustrates an internal structural view of sensors/circuitry/logic 16a . . . 16n of FIG. 1, in accordance with embodiments of the present invention. Sensors/circuitry/logic 16a . . . 16n includes sensors 318, a sensor interface module 304, a sensor control module 310, an analysis module 308, a control module 314, and communication controllers 302. Sensors 318 may include any type of internal or external sensors including, inter alia, optical sensors, temperature sensors, infrared sensors, speed sensors, GPS sensors, moisture sensors, pressure sensors, motion detector sensors, video cameras, etc. Sensor interface module 304 comprises specialized hardware and software for controlling all functions related to interfacing with sensors 16a . . . 16n and sensors 53. Sensor control module 310 comprises specialized hardware and software for controlling all functionality related to controlling all functions related to control of 16a . . . 16n and sensors 53 and implementing the process described with respect to the algorithm of FIG. 2. Analysis module 308 comprises specialized hardware and software for controlling all functions related steps 201 and 202 of FIG. 2. Control module 314 comprises specialized hardware and software for controlling (in combination with hardware device) functions related to executing vehicle control actions with respect to accessories 71 as described, supra. Communication controllers 502 are enabled for controlling all communications between sensors 318, sensor interface module 304, sensor control module 310, analysis module 308, and control module 314.

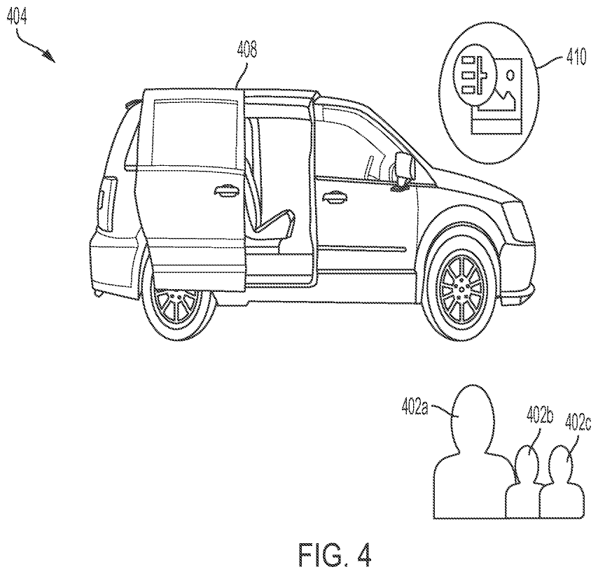

FIG. 4 illustrates an implementation example associated with detecting externally located occupants 402a . . . 402c of a vehicle 404, in accordance with embodiments of the present invention. Occupant 402a is a parent to occupants 402b and 402c and is the owner of vehicle 404. Vehicle 404 is equipped similarly to vehicle 22 of FIG. 1 and occupant 402a has configured control preferences such that if occupants 402b and 402c are adjacent to vehicle 404, a sliding door 408 will automatically open. Likewise, occupant 402a has configured control preferences such that if occupants 402b and 402c are not adjacent to vehicle 404, sliding door 408 will remain shut. Therefore, cameras and motion sensors 410 (of vehicle 404) are configured to determine that occupants 402a . . . 402c are approaching vehicle 404. Additionally, a controller in vehicle 404 is configured to determine (via image recognition with respect to data retrieved from cameras and motion sensors 410) that there is an authorized adult (i.e., occupant 402a) and two children (occupants 402b and 402c) adjacent to vehicle 404. Therefore (based on the preset preferences), sliding door 408 is automatically opened for occupants 402b and 402c.

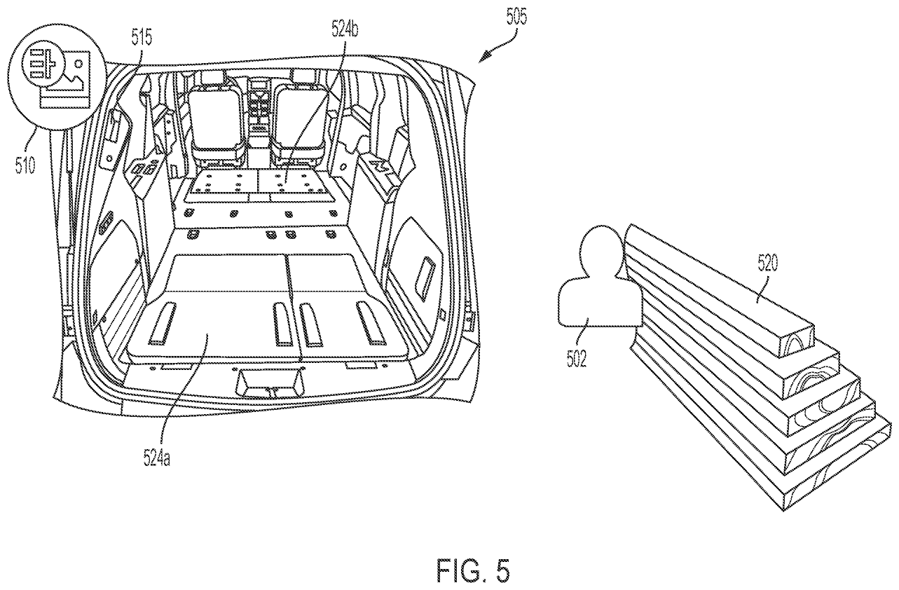

FIG. 5 illustrates an implementation example associated with detecting externally located items 520 to be loaded within a vehicle 505, in accordance with embodiments of the present invention. Vehicle 504 is owned by occupant 502. Vehicle 504 is equipped similarly to vehicle 22 of FIG. 1 and occupant 502 has configured control preferences such that if cargo (e.g., items 520) are placed adjacent to vehicle 504, a rear door 515 will automatically open and seats (e.g., seats 524a and 524b) will automatically fold down into a flat position. Therefore, cameras and motion sensors 510 (of vehicle 504) are configured to determine that occupant 502 is approaching vehicle 504. Additionally, a controller in vehicle 504 is configured to determine (via image recognition with respect to data retrieved from cameras and motion sensors 510) that there is an authorized adult (i.e., occupant 502) and items 520 adjacent to vehicle 504. Therefore (based on the preset preferences), rear door 515 is automatically opened and seats 524a and 524b are automatically folded down into a flat position.

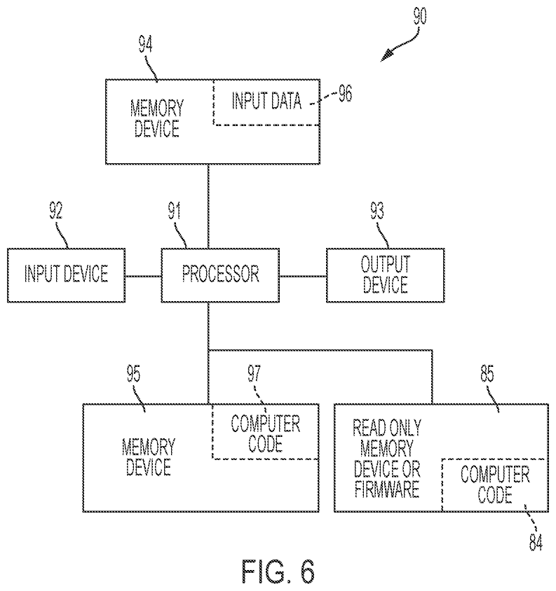

FIG. 6 illustrates a computer system 90 (e.g., hardware device 14 and communications module 57) for improving automotive technology by determining and executing vehicular control actions associated with external user actions, in accordance with embodiments of the present invention.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 6 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random-access memory (DRAM), a read-only memory (ROM), etc. The memory device 95 includes a computer code 97. The computer code 97 includes algorithms (e.g., the algorithm of FIG. 2) for improving automotive technology by determining and executing vehicular control actions associated with external user actions. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices Such as read only memory device 96) may include the algorithm of FIG. 2 and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including the algorithm of FIG. 2) may be stored on a static, nonremovable, read-only storage medium such as a Read-Only Memory (ROM) device 85, or may be accessed by processor 91 directly from such a static, nonremovable, read-only medium 85. Similarly, in some embodiments, stored computer program code 84 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve automotive technology by determining and executing vehicular control actions associated with external user actions. Thus the present invention discloses a process for deploying, creating, integrating, hosting, maintaining, and/or integrating computing infrastructure, including integrating computer-readable code into the computer system 90, wherein the code in combination with the computer system 90 is capable of performing a method for improving automotive technology by determining and executing vehicular control actions associated with external user actions. In another embodiment, the invention provides a business method that performs the process steps of the invention on a subscription, advertising, and/or fee basis. That is, a service supplier, such as a Solution Integrator, could offer to improve automotive technology by determining and executing vehicular control actions associated with external user actions. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

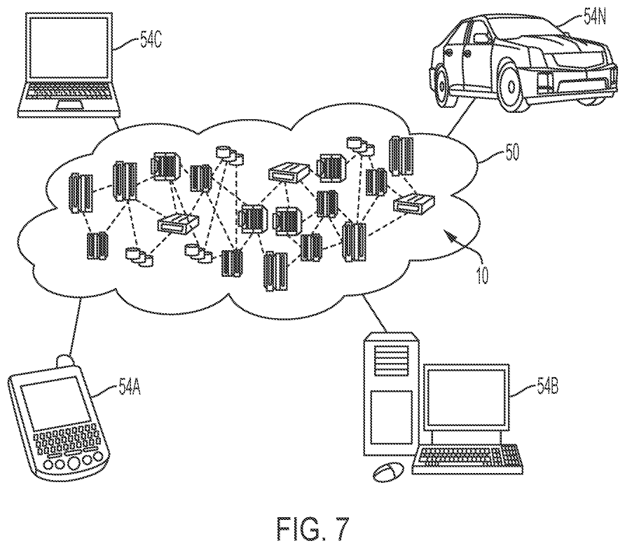

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser).

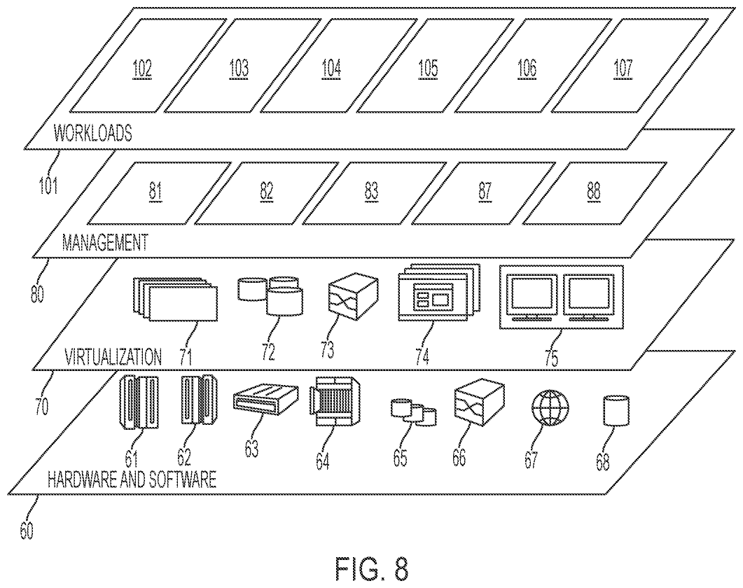

Referring now to FIG. 8, a set of functional abstraction layers provided by cloud computing environment 50 (see FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 101 provides examples of functionality for which the cloud computing environment may be utilized. Examples of workloads and functions which may be provided from this layer include: mapping and navigation 102; software development and lifecycle management 103; virtual classroom education delivery 104; data analytics processing 105; transaction processing 106; and for improving automotive technology by determining and executing vehicular control actions associated with external user actions 107.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A vehicular accessory control improvement method comprising:
continuously monitoring, by a processor of a hardware device within a vehicle via a plurality of sensors, user attributes associated with a plurality of user actions occurring exterior to said vehicle;
determining, by said processor based on results of said continuously monitoring, vehicle control actions associated with controlling devices of said vehicle in response to said plurality of user actions;
monitoring via a plurality of internal sensors of said vehicle, by said processor in response to said plurality of user actions, activities occurring within said vehicle;
executing, by said processor based on results of said monitoring, said vehicle control actions; and
generating, by said processor in response to said executing, self-learning software code associated with future instances of executing said vehicle control actions with respect to detecting future instances of said plurality of user actions.

2. The method of claim 1, wherein said plurality of sensors are comprised by said vehicle.

3. The method of claim 1, wherein said plurality of sensors are comprised by an Internet of Things (TOT) device of said user.

4. The method of claim 1, wherein said plurality of user actions comprise actions associated with items being purchased by said user.

5. The method of claim 1, wherein said plurality of user actions comprise actions associated with a plurality of individuals currently located with said user and allocated for entering said vehicle.

6. The method of claim 5, further comprising:
executing, by said processor, a facial image recognition process with respect to said plurality of individuals, wherein said executing said vehicle control actions is further based on results of said facial image recognition process.

7. The method of claim 1, wherein said plurality of user actions comprise actions associated with a current geographical location of said user.

8. The method of claim 1, further comprising:
alerting, by said processor, said user that said plurality of user actions are being executed.

9. The method of claim 1, wherein said vehicle control actions comprise actions selected from the group consisting of vehicle entry point actions, vehicle audio system actions, vehicle climate control actions, and vehicle convenience apparatus actions.

10. The method of claim 1, further comprising:
providing at least one support service for at least one of creating, integrating, hosting, maintaining, and deploying computer-readable code in the computing system, said code being executed by the computer processor to implement: said continuously monitoring, said determining, said monitoring, said executing, and said generating.

11. A computer program product, comprising a computer readable hardware storage device storing a computer readable program code, said computer readable program code comprising an algorithm that when executed by a computer processor of a hardware device, within a vehicle, implements a vehicular accessory control improvement method, said method comprising:
continuously monitoring, by said processor via a plurality of sensors, user attributes associated with a plurality of user actions occurring exterior to said vehicle;
determining, by said processor based on results of said continuously monitoring, vehicle control actions associated with controlling devices of said vehicle in response to said plurality of user actions;
monitoring via a plurality of internal sensors of said vehicle, by said processor in response to said plurality of user actions, activities occurring within said vehicle;
executing, by said processor based on results of said monitoring, said vehicle control actions; and
generating, by said processor in response to said executing, self-learning software code associated with future instances of executing said vehicle control actions with respect to detecting future instances of said plurality of user actions.

12. The computer program product of claim 11, wherein said plurality of sensors are comprised by said vehicle.

13. The computer program product of claim 11, wherein said plurality of sensors are comprised by an Internet of Things (TOT) device of said user.

14. The computer program product of claim 11, wherein said plurality of user actions comprise actions associated with items being purchased by said user.

15. The computer program product of claim 11, wherein said plurality of user actions comprise actions associated with a plurality of individuals currently located with said user and allocated for entering said vehicle.

16. The computer program product of claim 15, wherein said method further comprises:
executing, by said processor, a facial image recognition process with respect to said plurality of individuals, wherein said executing said vehicle control actions is further based on results of said facial image recognition process.

17. The computer program product of claim 11, wherein said plurality of user actions comprise actions associated with a current geographical location of said user.

18. The computer program product of claim 11, wherein said method further comprises:
alerting, by said processor, said user that said plurality of user actions are being executed.

19. The computer program product of claim 11, wherein said vehicle control actions comprise actions selected from the group consisting of vehicle entry point actions, vehicle audio system actions, vehicle climate control actions, and vehicle convenience apparatus actions.

20. A hardware device, within a vehicle, comprising a computer processor coupled to a computer-readable memory unit, said memory unit comprising instructions that when executed by the computer processor implements a vehicular accessory control improvement method comprising:
continuously monitoring, by said processor via a plurality of sensors, user attributes associated with a plurality of user actions occurring exterior to said vehicle;
determining, by said processor based on results of said continuously monitoring, vehicle control actions associated with controlling devices of said vehicle in response to said plurality of user actions;
monitoring via a plurality of internal sensors of said vehicle, by said processor in response to said plurality of user actions, activities occurring within said vehicle;
executing, by said processor based on results of said monitoring, said vehicle control actions; and
generating, by said processor in response to said executing, self-learning software code associated with future instances of executing said vehicle control actions with respect to detecting future instances of said plurality of user actions.
